(19) United States
(12) Patent Application Publication
(10) Pub. No.: US 2016/0020640 A1
(43) Pub. Date: Jan. 21, 2016

(54) Portable Method for Charging Mobile Devices

(71) Applicant: Jessica Kristin Rogers, Austin, TX (US)

(72) Inventor: Jessica Kristin Rogers, Austin, TX (US)

(21) Appl. No.: 14/803,585

(22) Filed: Jul. 20, 2015

Related U.S. Application Data
(60) Provisional application No. 62/026,740, filed on Jul. 21, 2014.

(51) Int. Cl. H02J 7/02; H02J 7/00

(52) U.S. Cl. CPC H02J 7/025; H02J 7/0055; H02J 7/0042; H02J 2007/0062

(57) ABSTRACT

The invention provides an improved system for organizing mobile and portable electronic devices for individuals by allowing them to remain in the bag or container they will be carried in while being charged. This allows an individual to simply unplug the charging device built into the bag when appropriate, and takes the bag, which they typically carry with them to the next location of travel. This allows all desired devices to be already grouped together and placed in container with other objects possibly including wallet or business items prior to travel thereby eliminating additional steps to organize and pack bag on a regular or daily basis.

### CROSS-REFERENCE TO RELATED APPLICATIONS

This application claims the benefit of U.S. provisional application No. 62/026,740 filed on Jul. 21, 2014.

### REFERENCES CITED [Referenced By]

U.S. patent Documents

| | | |
|---|---|---|
| 9,071,698 | Inha, Kai | Jun. 30, 2015 |
| 8,673,468 | Kim, et al. | Mar. 18, 2014 |
| 8,668,506 | Stack, et al. | Mar. 11, 2014 |
| 8,658,307 | Byun, et al. | Feb. 25, 2014 |
| 8,645,731 | Van Der Velden, Frank | Feb. 4, 2014 |
| 8,629,652 | Partovi, et al. | Jan. 14, 2014 |
| 8,497,658 | Von Novak, et al. | Jul. 30, 2013 |
| 8,188,619 | Azancot, et al. | May 29, 2012 |
| 8,169,185 | Partovi, et al. | May 1, 2012 |
| 8,090,550 | Azancot, et al. | Jan. 3, 2012 |
| 7,952,322 | Partovi, et al. | May 31, 2011 |
| 7,948,208 | Paartovi, et al. | May 24, 2011 |
| 5,963,012 | Garcia, et al. | Oct. 5, 1999 |
| 5,596,567 | deMuro, et al. | Jan. 21, 1997 |

### FEDERALLY SPONSORED RESEARCH

Not Applicable

### SEQUENCE LISTING REFERENCE

Not Applicable

### STATEMENT OF PRIOR ART DISCLOSURES

U.S. Patent Application 20150188353

Inventor: Lee, Hsueh-Han

Filed: Jul. 2, 2015

More options are becoming available for wireless charging of a device. This allows devices to charge without direct coupling of each device to an electrical source. This describes a wireless charging device, which includes a wireless transmitting module and a wireless receiving module. Addressing the problem where portable electronic products must be powered through the adaptor or by a rechargeable battery. Those who attempt to carry these products otherwise must also carry assorted adaptors or chargers.

U.S. Pat. No. 9,071,698

Inventor Inha; Kai

Issued: Jun. 30, 2015

The present invention provides a charging device for a portable electronic device, the charging device arranged to provide power to the portable electronic device upon physical coupling with the portable electronic device, the charging device comprising one or more charging couplings to provide physical coupling of the charging device to a portable electronic device wherein the charging device is arranged to transmit power and data via one or more of the couplings.

U.S. Pat. No.: 5,963,012

Inventor: Garcia, et al.

Issued: Oct. 5, 1999

There are other patents designed for wireless battery charging system between the charger and device. U.S. Pat. No. 5,963,012 describes a battery charging system with a means for determining both static and dynamic charging parameters of a battery prior to and during a battery charging operation. The communication between the charger and the battery is provided by wireless communication link and includes static parameters such as battery capacity and chemistry type, and dynamic parameters such as temperature, pressure and voltage. The apparatus is particularly suited for contactless inductive battery charging systems.

U.S. Pat. No. 5,596,567

Inventor: deMuro, et al.

Issued: Jan. 21, 1997

Some prior art documents have suggested multi-purpose chargers capable of determining battery-charging parameters from the battery packs themselves. For example, U.S. Pat. No. 5,596,567 describes a battery charging system in which a battery pack with a wireless communication module for a battery charger to read this information and thus determine how the battery should be charged is also provided with a memory for storing data specific to the battery and/or battery type. The wireless communication system is therefore short range to avoid confusion with other battery packs.

### BACKGROUND OF INVENTION

The use of wireless non-contact systems are increasing in importance and are a popular functionality. Wireless charging technology is being embedded into mobile electronic devices, personal digital assistants, notebook computer systems, mobile accessories and consumer electronics. Charging surfaces are able to recharge single or multiple devices simultaneously. Companies work with wireless power and work to provide it within easy reach for their customers. This innovation provides a similar solution for individuals whether desiring to charge multiple mobile devices or only one, in or outside of home with improved level of simplification, organization and safety. As people began to carry and utilize greater number of mobile devices on a daily basis, getting all devices charged and together before leaving a location becomes a greater challenge. This innovation also allows individuals to save time, steps and risk of forgetting or losing an item before leaving a location.

### FIELD OF INVENTION

The present innovation relates to utilizing the field of charge for electronic devices, particularly mobile and portable devices chargeable by wired, wireless connections in a group held together and therefore designed to carry or transport as desired with other items.

### BRIEF SUMMARY OF INVENTION

The purpose of this invention is to save time and effort for individuals that desire or need to organize, simplify and carry multiple rechargeable devices with them. This innovation allows one or multiple rechargeable devices to remain together in carrying object while charging takes place. This allows a user once ready to simply unplug carrying case or multifunctional carrying bag and leave without additional steps of collecting the multiple portable devices and placing them together in a bag or case before leaving.

This set up is designed into cases, purses, bags, luggage and other carrying containers to allow individuals to increase efficiency in their routine. As needed this will allow multiple mobile devices to be charged while remaining in the bag/container within which they will travel. This system therefore ensures saved time and organization for the user. This innovation also allows individuals to charge devices at home and other location sites with decreased chance of losing, misplacing and forgetting individual rechargeable devices.

### BRIEF DESCRIPTION OF DRAWING

Not Applicable

### DETAILED DESCRIPTION OF THE INVENTION

The description includes several embodiments of the present invention. The inventor presents what is believed the best and most practical presentation for utilizing this method. The inventor realizes that because other electronic devices, including small wearable devices including wristwatches, headgear and hearing aids may require different configuration, different shaped charging panels and different shaped compartments to protect as well as to utilize in the manner described. However, the inventor intends for these various and differently shaped devices to be included within the scope of this application.

In addition it is recognized that as technology develops a number of additional alternatives to achieve an aspect of the invention may arise, including but not limited to various methods for recharging internal batteries within portable electronic devices. Such advances are within the scope of the present invention, and should be recognized as being functionally equivalent or structurally equivalent to the aspect described herein.

As technology advances other means of providing power to portable electronic devices may be achieved alternatively to the rechargeable battery. This, however, may be extended to apply to other sources of rechargeable power that may be imbedded into portable electronic devices like the mobile phone.

The user keeps or places needed mobile devices in their bag and plugs in the charging apparatus or devices for a desired period of time. Once needed the user unplugs the charging apparatus and then takes their carrying device with them to their next destination. Locating and unplugging multiple devices and placing them in a carrying device no longer required.

This method provides for a carrying or roller bag designed to hold a wireless charging device(s) for utilization to recharge portable electronic devices. The portable electronic devices are typically stored or carried in a compartment where the wireless charging device can be utilized to recharge the electronic devices as intended when desired.

One example, the charging device, typically a pad or panel is attached inside of a bag in an upright orientation creating a longitudinal divider inside the bag. So in a simple bag the divider would create two pockets with the same basic length and height. One side of the pocket would be designed to place and store the mobile devices. There may be additional straps present to secure devices against charging panel and prevent any overlap or misalignment of electronic devices. Any material present would be minimal enough not to interfere with charging the portable electronic devices.

In this example, when intended to utilize the charging panel the bag is placed on its side so the portable electronic devices are resting on top of the panel. If extra straps to secure devices are not in place the user may need to double check and correct orientation of portable electronic devices. The charging panel may then be turned on or plugged into an external power supply as needed. While in this position the portable electronic devices are recharged.

Once recharging is complete an individual simply needs to unplug the wireless charging panel if needed, pick up or place bag where needed travel with them and continue with any plans and travel for the day. The electronic devices remain together in bag until individual relocates or desires for their use.

The invention claimed is:

1. Charging panel inside of bag.

2. The charging panel of claim 1 wherein the present invention provides a charging device for a portable electronic device.

3. The portable electronic device of claim 2 additionally includes mobile devices, hand-held devices, data enabled, small battery powered, charging port, mobile phones, personal digital assistants, notebook computer systems, mobile accessories, consumer electronics and the like.

4. Charging panel of claim 1 wherein provides power to portable electronic device via a wired charging connection, wireless non-contact system which may utilize a wireless charging plane and is arranged to provide power to the portable electronic device upon physical coupling with the portable electronic element or elements.

5. Charging panel of claim 4 includes a charging mat, panel, surface, charging orb or combination thereof.

6. Charging panel of claim 1 wherein can be of solid planar orientation, flexible, capable of bending, folding, hinging or combination thereof.

7. Charging panel of claim 1 additionally can be of singular nature inside bag or consist of multiple charging panels and provides a charging surface on one or more sides, one or more location or additional side and location.

8. The charging panel of claim 1 wherein is a device comprising one or more charging couplings to provide physical coupling of the charging device to a portable electronic device, wherein the charging device is arranged to transmit power or power and data via one or more of the couplings.

9. Charging panel of claim 1 wherein transference of power to charging panel can include an external power source, AC power, AC converter, AC/DC converter, cable with USB type connector(s), USB receptacles(s), region-specific power connector (to wall outlet), captive cable (with micro-USB connector), similar external power supply and connecting cable.

10. Bag noted of claim 1 wherein can includes a purse, handbag, briefcase, luggage, business bag, backpack, tote bag, messenger bag, knapsack, duffle bag, travel bag, laptop tote and of similar style and intention.

11. The charging panel of claim 1 wherein each support surface member secures to an inner surface of the bag and is designed to fit there within.

12. The charging panel of claim 1 additionally is secured inside bag by stitching, Velcro, pouch, other textile component, soft or solid member to comprise a partial or encompassing compartment or combination thereof.

13. Access to utilize the charging panel of claim 1 additionally is via but not limited to pouch, straps, bands, elastic, zipper, pocket or other accessories or combination of these built into design of the bag to secure portable electronic devices into position in relation for effective use of charging panel.

14. Charging panel of claim 1 additionally is attached primarily but not limited to on border of the charging panel which to secure in place and allow access to utilize panel for charging portable devices.

15. Access to external power by charging panel of claim 1 wherein is enabled by accessible port to withdraw or place to connect connecting cable to charging outlet through opening or smaller pocket designed and present into portion of bag.

16. Charging panel of claim 1 additionally is attached into any layer of bag providing orientation for charging to take place while bag oriented in upright alignment, orientation on side or specified positioning.

17. Attachment of charging panel of claim 1 additionally can be intended for permanent attachment or temporary thereby allowing replacement of charging panel as desired.

18. The face of charging panel of claim 1 additionally is exposed to allow adequate contact of portable devices to charging panel.

19. The face of charging panel of claim 1 wherein is not exposed, covering is of minimal to none inhibition towards ability to charge portable devices.

20. The use of charging panel of claim 1 additionally may be specific to facilitate the charging of portable devices.
